(19) United States
(12) Patent Application Publication
(10) Pub. No.: US 2011/0119992 A1
(43) Pub. Date: May 26, 2011

(54) OXIDATION RESISTANT INTERSTITIAL METAL HYDRIDE CATALYSTS AND ASSOCIATED PROCESSES

(75) Inventors: Faiz Pourarian, Wexford, PA (US); Marc A. Portnoff, Pittsburgh, PA (US); David A. Purta, Gibsonia, PA (US); Margaret A. Nasta, McKeesport, PA (US); Jingfeng Zhang, Gibsonia, PA (US); Gordon F. Stuntz, Baton Ruge, LA (US); Jonathan M. McConnachie, Annandale, NJ (US); Heather A. Elsen, Bethlehem, PA (US); Patricia A. Bielenberg, Easton, PA (US)

(73) Assignee: EXXONMOBIL RESEARCH AND ENGINEERING COMPANY, Annandale, NJ (US)

(21) Appl. No.: 12/948,576

(22) Filed: Nov. 17, 2010

Related U.S. Application Data
(60) Provisional application No. 61/281,949, filed on Nov. 24, 2009.

(51) Int. Cl. C10L 1/00; C10G 47/02; C10G 45/00; C10G 45/22; B01J 21/08; B01J 21/06; C10G 73/02

(52) U.S. Cl. 44/307; 208/28; 208/112; 208/143; 208/216 R; 208/217; 208/253; 208/254 H; 502/1; 502/242; 502/308; 502/335; 502/337; 208/213

(57) ABSTRACT

The present invention relates to novel interstitial metal hydrides and catalyst containing interstitial metal hydrides that are resistant to oxidation and resultant loss of catalytic activity. The processes of the present invention include use of these improved, oxidation resistant interstitial metal hydride compositions for improved overall hydrogenation, product conversion, as well as sulfur reduction in hydrocarbon feedstreams.

This application claims the benefit of U.S. Provisional Application No. 61/281,949 filed Nov. 24, 2009.

### FIELD OF THE INVENTION

The present invention relates to novel interstitial metal hydrides and catalyst containing interstitial metal hydrides that are resistant to oxidation and resultant loss of catalytic activity. The processes of the present invention include use of these improved, oxidation resistant interstitial metal hydride compositions for improved overall hydrogenation, product conversion, as well as sulfur reduction in hydrocarbon feedstreams.

### DESCRIPTION OF RELATED ART

As the demand for hydrocarbon-based fuels has increased, the need for improved processes for desulfurizing hydrocarbon feedstreams has increased as well as the need for increasing the conversion of the heavy portions of these feedstreams into more valuable, lighter fuel products. These hydrocarbon feedstreams include, but are not limited to, whole and reduced petroleum crudes, shale oils, coal liquids, atmospheric and vacuum residua, asphaltenes, deasphalted oils, cycle oils, FCC tower bottoms, gas oils, including atmospheric and vacuum gas oils and coker gas oils, light to heavy distillates including raw virgin distillates, hydrocrackates, hydrotreated oils, dewaxed oils, slack waxes, raffinates, biofuels, and mixtures thereof.

Hydrocarbon streams boiling above 430° F. (220° C.) often contain a considerable amount of large multi-ring hydrocarbon molecules and/or a conglomerated association of large molecules containing a large portion of the sulfur, nitrogen and metals present in the hydrocarbon stream. A significant portion of the sulfur contained in these heavy oils is in the form of heteroatoms in polycyclic aromatic molecules, comprised of sulfur compounds such as dibenzothiophenes, from which the sulfur is difficult to remove.

The high molecular weight, large multi-ring aromatic hydrocarbon molecules or associated heteroatom-containing (e.g., S, N, O) multi-ring hydrocarbon molecules in heavy oils are generally found in a solubility class of molecules termed as asphaltenes. A significant portion of the sulfur is contained within the structure of these asphaltenes or lower molecular weight polar molecules termed as “polars” or “resins”. Due to the large aromatic structures of the asphaltenes, the contained sulfur can be refractory in nature and can be difficult to remove. In conventional refining processes, sulfur compounds are removed in refinement processes from various hydrocarbon streams by “cracking” the petroleum oils in the presence of a metal catalyst and hydrogen. These conventional refining processes for sulfur removal from hydrocarbon streams, by such names as “hydrodesulfurization” processes or “hydrocracking” processes, are well known in the industry. In these catalytic processes, the sulfur-containing hydrocarbon streams are contacted with catalysts containing hydrogenation metals, typically belonging to Groups 6, 8, 9 and 10 of the Periodic Table (based on the 1990 IUPAC system wherein the columns are numbered from 1 to 18) and in the presence of hydrogen at elevated temperatures and pressures to promote molecular cracking and heteroatom removal.

In these processes, the sulfur atoms in the hydrocarbon streams are exposed or separated from the oil and are able to react with hydrogen which is then liberated from the process typically in the form of a hydrogen sulfide gas. In these processes, nitrogen is also removed to some extent from the hydrocarbon streams (i.e., “denitrogenation”) and metals (i.e., “demetalization”) are also removed to some extent from the hydrocarbon streams. However, sometimes, nitrogen and/or metals are targeted for removal by “pre-processing” the hydrocarbon streams and removing a portion of the nitrogen and/or metals prior to contacting the hydrodesulfurization or hydrocracking catalysts. Additionally, in these processes, some of the larger hydrocarbon molecules are “cracked” into smaller hydrocarbon molecules. This is generally called “cracking” or “conversion” and is a significant part of many of these hydroprocessing processes as this converts heavier, low value petroleum streams, such as gas oils and resids, into higher value products such as transportation fuels, for example, gasolines, jet fuels, and diesels.

An alternative modification to conventional hydroprocessing has been proposed in U.S. Pat. Nos. 7,157,401 and 7,387,712 to Purta et al, which are incorporated herein by reference. In these processes, petroleum oils are contacted with interstitial metal hydride (“iMeH”) catalysts under mild conditions for hydrogenation of molecules. In particular, these patents disclose three specific compositions of iMeHs disclosed as Cat 100 (or “AT₅ type”), CAT 200 (or “A₂T₁₄B type”) and CAT 300 (or “A₂T type”).

However, a major problem facing the use of the interstitial metal hydrides catalysts lies in the fact that these interstitial metal hydride catalysts are easily oxidized in the environment and once oxidized, the hydroprocessing activity of the interstitial metal hydrides is most often severely diminished and not susceptible to recovery under hydroprocessing conditions. This problem of oxidation of the iMeH catalysts is clearly identified in the U.S. Pat. Nos. 7,157,401 and 7,387,712 as well as the resulting necessity to the maintain these iMeH catalysts under inert environments interstitial metal hydrides prior to use in order to avoid the oxidation and deactivation of the catalysts. This oxidation occurs when interstitial metal hydrides are exposed to an oxidizing environment, such as an oxygen-containing atmosphere (including, but not limited to, both air and water), wherein the interstitial metal catalysts develop a hard “oxide shell” which severely inhibits the monatomic hydrogen flow in and out of the iMeH lattice, which function is of critical to their importance as use as hydroprocessing catalysts or catalyst components. Once formed on the iMeH and/or in the iMeH lattice structure, this oxide shell significantly impedes hydrogen transfer into and out from the iMeH under hydroprocessing conditions.

As a result, the iMeH catalysts require considerable special handling in inert environments all through processes from fabrication, shipping, loading, use, and maintenance of the catalyst systems to protect the activity of the interstitial metal hydride components. These are all very labor extensive and costly steps in maintaining the catalyst under an inert environment through all of these steps from fabrication to use. Additionally, all of these steps involve some risk that the interstitial metal hydride can be exposed to oxygen or contaminated during these processes. There are also additional inherent significant safety risks to be considered when handling the iMeH catalysts under inert environments as the iMeH catalysts can be pyrophoric in nature wherein an inadvertent exposure of the iMeH catalyst to oxygen under improper conditions may result in combustion of the catalyst. Additionally, when working in and with inert atmospheres, there is always the possibility of asphyxiation of personnel if improperly exposed to the inert environment associated with the iMeH catalyst.

What is needed in the industry are new interstitial metal hydride catalysts that are resistant to the effects of oxidation and can operate efficiently and effectively under hydroprocessing conditions even after exposure to oxidizing atmospheres, thereby improving the ease of manufacturing and handling of such interstitial metal hydrides for use.

### SUMMARY OF THE INVENTION

The current invention embodies interstitial metal hydrides catalysts that have been found resistant to oxidizing atmospheres and their resultant reduced activation in hydroprocessing processes. These new interstitial metal hydrides allow for simple and facile catalyst manufacture, transportation and handling due to their oxidation resistant nature while maintaining activities for effective hydroprocessing of hydrocarbon-containing feedstreams. These new catalysts containing interstitial metal hydrides (“iMeH”s) eliminate the need for maintenance under strict inert environments as required by the prior art interstitial metal hydride catalysts. These catalysts can be exposed to oxidizing atmospheres and still maintain at or near their “non-oxidized” activity levels when used in hydroprocessing processed to produce a hydrocarbon product stream with improved product qualities. Use of these oxidation resistant interstitial metal hydride catalysts can result in significantly reduced costs, contamination exposures, and personnel safety dangers associated with the necessity of maintaining the iMeH catalysts under inert environments.

The current invention embodies catalysts and processes for hydroprocessing a hydrocarbon-containing feedstream to produce a product stream with improved product qualities by utilizing “oxidation resistant” interstitial metal hydride (“iMeH”) catalysts under hydroprocessing conditions. These “improved product qualities” include, but are not limited to increased hydrogenation (or increased hydrogen content by weight), conversion or “cracking to a lower average boiling point conversion, higher API gravity, reduced viscosity, as well as lowered levels of sulfur, nitrogen and metals. The current processes utilize new interstitial metal hydrides which have unexpectedly shown a significant resistance to oxidation while maintaining high levels of hydride catalytic activity, especially under severe hydroprocessing conditions. The terms “high pressure/high severity” and “severe” hydroprocessing conditions and/or processes are equivalents as utilized herein and are defined as hydroprocessing processes wherein a hydrocarbon feedstream is contacted with a hydroprocessing catalyst in the presence of hydrogen under process conditions of at least 400 psig and at least 200° C.

A preferred embodiment of the present invention is a catalyst comprised of an interstitial metal hydride having a compositional formula of A₁₋ₓBₓT_{(1-y)±d1}C_{y±d2}, wherein:
A=Zr; B=at least one of Ti and Hf; T=Ni; C=at least one of Cr, Mn, Fe, Co, and Cu; and
x=0.0 to 1.0; and y=0.0 to 1.0; and
d₁=0.00 to 0.2; and d₂=0.00 to 0.2.

In another preferred embodiment of the catalyst of the present, the interstitial metal hydride has been exposed to an oxidizing atmosphere. In yet another preferred embodiment of the catalyst of the present, the interstitial metal hydride has been exposed to air. In another preferred embodiment of the catalyst of the present, the interstitial metal hydride is oxidized.

In an even more preferred embodiment, interstitial metal hydride catalyst is part of a co-catalyst which contains at least one transition metal element selected from Mo, W, Fe, Co, Ni, Pd, and Pt.

A preferred embodiment of the present invention is a process utilizing the embodiments of the catalyst of the present invention in a process for upgrading a hydrocarbon feedstream comprised of:
a) contacting a hydrocarbon feedstream with a catalyst comprised of an interstitial metal hydride in the presence of hydrogen at process reaction conditions of at least 200° C. and at least 400 psig; and
b) obtaining an upgraded reaction product stream;
wherein the interstitial metal hydride has a compositional formula of A₁₋ₓBₓT_{(1-y)±d1}C_{y±d2}, wherein:
A=Zr; B=at least one of Ti and Hf; T=Ni; C=at least one of Cr, Mn, Fe, Co, and Cu; and
x=0.0 to 1.0; and y=0.0 to 1.0; and
d₁=0.00 to 0.2; and d₂=0.00 to 0.2.

More preferably, the process is performed in the presence of a hydrogen-rich gas containing at least 50 mol % hydrogen, and even more preferably, the process reaction conditions are least 200° C. and at least 600 psig, and the hydrogen partial pressure during the process reaction is at least 500 psia to produce an upgraded reaction product stream.

In another preferred embodiment of the process of the present invention, the interstitial metal hydride catalyst is a co-catalyst and the co-catalyst contains at least one transition metal element selected from Mo, W, Fe, Co, Ni, Pd, and Pt. In another even more preferred embodiment of the process, the transition metal element is in the sulfided metal condition.

In another preferred embodiment of the process of the present invention, the hydrocarbon feedstream and interstitial metal hydride are further subjected to radio frequency energy or microwave frequency energy while under the reaction conditions.

### BRIEF DESCRIPTION OF THE FIGURES

FIG. 1 is a graph comparing the “% Maintenance of Hydroprocessing Activity after Oxidation” of the interstitial metal hydrides (“iMeHs”) of the prior art (CAT 100, CAT 200, and CAT 300) to those of the oxidation resistant iMeHs (CAT 500 compositions) of the present invention at conditions of 200° C. and 400 psig. The “% Maintenance of Hydroprocessing Activity after Oxidation” is based on a ratio of each iMeH's first order rate constant after oxidation divided by the iMeH's first order rate constant prior to oxidation (expressed in percentage, %) for each of the three model compounds tested.

FIG. 2 is a schematic of a preferred reaction process configuration using the iMeH catalysts of the present invention.

### DETAILED DESCRIPTION OF THE INVENTION

The current invention embodies processes for hydroprocessing a hydrocarbon-containing feedstream to produce a product stream with improved product qualities by utilizing novel oxidation resistant interstitial metal hydride (“iMeH”) catalysts under high pressure/high severity hydroprocessing conditions. These “improved product qualities” include, but not limited, to increased hydrogenation (or increased hydrogen content by weight), lower average boiling point conversion (or “cracking”), higher API gravity, reduced viscosity, and lower levels of sulfur, nitrogen, and metals. The current processes utilize these new “high severity hydroprocessing” interstitial metal hydride catalysts which have unexpectedly shown improved hydrocarbon conversion performance over the interstitial metal hydrides of the prior art under severe hydroprocessing conditions. The terms “high pressure/high severity” and “severe” hydroprocessing conditions and/or processes are equivalents as utilized herein and are defined as hydroprocessing processes wherein a hydrocarbon feedstream is contacted with a hydroprocessing catalyst in the presence of hydrogen at process conditions of least 400 psig and at least 200° C.

It should be noted here that the terms “hydrocarbon-containing stream”, “hydrocarbon stream” or “hydrocarbon feedstream” as used herein are equivalent and are defined as any stream containing at least 75 wt % hydrocarbons. These hydrocarbon feedstreams may be comprised of either “petroleum-based hydrocarbons”, “biofuel hydrocarbons”, or combinations thereof. The “petroleum-based hydrocarbons” are hydrocarbons obtained or derived hydrocarbonaceous materials from geological formations such as, but not limited to, crude oils, and oils derived from coal, tar sands, or bitumens, as well as any intermediate hydrocarbon or final hydrocarbon product derived from these sources. These are generally considered as non-renewable hydrocarbon sources.

As used herein, the terms “heavy hydrocarbon” or “heavy hydrocarbon stream” are equivalent and are defined herein as a subset of “petroleum-based hydrocarbons” and include hydrocarbon-containing streams containing at least 75 wt % hydrocarbons and having an API gravity of less than 20. Preferred heavy hydrocarbon streams for use in the present invention include, but are not limited to low API gravity, high sulfur, high viscosity crudes; tar sands bitumen; liquid hydrocarbons derived from tar sands bitumen, coal, or oil shale; as well as petrochemical refinery heavy intermediate fractions, such as atmospheric resids, vacuum resids, and other similar intermediate feedstreams and mixtures thereof containing boiling point materials above about 343° C. (650° F.). Heavy hydrocarbon streams may also include a blend of the hydrocarbons listed above with lighter hydrocarbon streams for control of certain properties for transport or sale, such as, but not limited to fuel oils and crude blends.

As used herein, the term “biofuel hydrocarbons” or “biofuels” are equivalent and are a sub-set of hydrocarbon streams, and are defined as hydrocarbon-containing streams wherein at least 50 wt % of the hydrocarbon material in the hydrocarbon-containing stream is derived from renewable biomass resources. These biomass resources include any plant or animal derived organic matter, such as dedicated energy crops and trees, agricultural food and feed crops, agricultural crop wastes and residues, wood wastes and residues, aquatic plants, algae, fungi, plant oils, animal oils, animal tissues, animal wastes, municipal wastes, and other waste materials. Biofuels may include, but are not limited to hydrocarbons in the middle distillate range, diesels, kerosenes, gasoline, gasoline fractions, biodiesel, biojet fuel, biogasolines and combinations thereof.

As used herein, the term “plant oil” is a subset of biofuels and is defined as a hydrocarbon-containing material derived from plant sources, such as agricultural crops and forest products, as well as wastes, effluents and residues from the processing of such materials. Plant oils may include vegetable oils. Examples of plant oils may include, but are not limited to, canola oil, sunflower oil, soybean oil, rapeseed oil, mustard seed oil, palm oil, corn oil, soya oil, linseed oil, peanut oil, coconut oil, corn oil, olive oil, and combinations thereof.

As used herein, the term “animal oil” is a subset of biofuels and is defined as a hydrocarbon-containing material derived animal sources, as well as wastes, effluents and residues from the processing of such materials. Examples of animal oils may include, but are not limited to, animal fats, yellow grease, animal tallow, pork fats, pork oils, chicken fats, chicken oils, mutton fats, mutton oils, beef fats, beef oils, and combinations thereof.

In the current invention are presented new “oxidation resistant” iMeHs that provide significantly improved resistance to the oxidative effects when using such iMeH catalysts in hydroprocessing of hydrocarbon streams. This problem of oxidation of the iMeH catalysts is clearly identified in the U.S. Pat. Nos. 7,157,401 and 7,387,712 as well as the resulting necessity to the maintain iMeH catalysts under inert environments prior to use in order to avoid the oxidation and deactivation of the catalysts. This oxidation occurs when interstitial metal hydrides are exposed to an oxidizing environment, such as an oxygen-containing atmosphere (including, but not limited to, both air and water), wherein it is believed that the interstitial metal catalysts develop a hard “oxide shell” which severely inhibits the monatomic hydrogen flow in and out of the iMeH lattice, which function is of critical to their importance as use as hydroprocessing catalysts or catalyst components. Once formed on the iMeH and/or in the iMeH lattice structure, this oxide shell significantly impedes hydrogen transfer into and out from the iMeH. Even under severe hydroprocessing conditions exceeding 200° C. and 400 psig, the effects of this oxidation are clearly seen.

What has unexpectedly been discovered herein is new “oxidation resistant” iMeH catalysts and associated processes that possess significant oxidation resistive improvements over the prior art when used in hydroprocessing of hydrocarbon feedstreams/materials. This new family of “oxidation resistant” iMeH catalysts is also referred to herein by the equivalent terms of the “CAT 500 iMeH compositions”, “CAT 500 iMeH”, “CAT 500 catalysts”, or simply “CAT 500”.

As utilized herein, the terms “interstitial metal hydride” or “iMeH” are equivalents and these terms as utilized herein are defined as materials that are composed of alloyed metals combined with atomic hydrogen, wherein the atomic hydrogen is stored interstitially within the metal alloy matrix.

In particular to this invention are the “oxidation resistant” iMeHs or

“CAT 500” catalyst compositions. It should be noted that the composition of the CAT 500 elements can be either stoichiometric or non-stoichiometric. The compositional formulations of CAT 500 are shown as follows. It should be noted that when d₁=0 and d₂=0, a stoichiometric composition of CAT 500 is shown.

CAT 500
AT Type
Crystal Structure: Orthorhombic-CrB-type

General Formula: A₁₋ₓBₓT_{(1-y)±d1}C_{y±d2}
wherein:
A=Zr; B=at least one of Ti and Hf; T=Ni; C=at least one of Cr, Mn, Fe, Co, and Cu; and
x=0.0 to 1.0; and y=0.0 to 1.0; and
d₁=0.00 to 0.2; and d₂=0.00 to 0.2

In a preferred embodiment of CAT 500, d₁=0; and d₂=0 (stoichiometric only compositions).

In a preferred embodiment of CAT 500, d₁=0.05 to 0.2; and d₂=0.05 to 0.2 (non-stoichiometric only compositions). In an even more preferred embodiment of CAT 500, d₁=0.05 to 0.1; and d₂=0.05 to 0.1.

In a preferred embodiment of CAT 500, B═Ti and C=at least one of Mn and Fe.

In another preferred embodiment of CAT 500, x=0.2 to 0.8; and y=0.2 to 0.8.

In another preferred embodiment of CAT 500, B═Ti; C=at least one of Mn and Fe; x=0.2 to 0.8; and y=0.2 to 0.8.

In yet another preferred embodiment of CAT 500, B═Ti; C=at least one of Mn and Fe; x=0.2 to 0.4; and y=0.2 to 0.4.

In yet another preferred embodiment of CAT 500, B═Ti; C=at least one of Mn and Fe; x=0.2 to 0.4; and y=0.

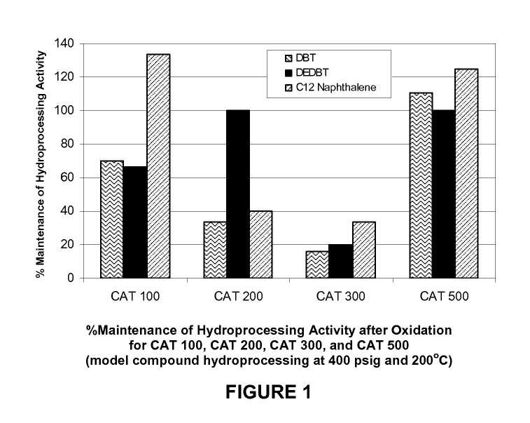

Example 1 herein describes how the prior art CAT 100, 200, and 300 iMeH catalysts as well as the oxidation resistant CAT 500 catalysts of the present invention were fabricated for the performance testing performed as detailed in Example 2 herein. Testing was performed as detailed in Example 2 to measure the first order rate constants for each of the iMeH catalysts tested for each of the three (3) model compounds tested in both the iMeHs' non-oxidized and oxidized conditions. The ratio of the “oxidized” first order rate constant to the “non-oxidized first order rate constant for each iMeH for each model compounds was then calculated to show the percentage of the original hydroprocessing activity (based on the non-oxidized sample) that is maintained after the iMeH sample has been oxidized. The results from the testing of this example (in percent hydroprocessing activity maintained after oxidation) are presented in Table 1 and are shown graphically in FIG. 1, herein.

The first order rate constant is calculated by the formula:

First Order Rate Constant=space velocity×ln(reactant concentration in feed/reactant concentration in the product)

TABLE 1
% Maintenance of Hydroprocessing Activity after Oxidation For Model Compounds
(based on First Order Rate Constants) (at 400 psig and 200° C.)

| | | % Maintenance of | % Maintenance of |
|---|---|---|---|
| | % Maintenance of | Hydroprocessing | Hydroprocessing |
| | Hydroprocessing | Activity | Activity |
| | Activity | (Diethyl- | (Dodecyl- |
| iMeH Catalyst ID | (Dibenzothiophene) | Dibenzothiophene) | Naphthalene) |
| CAT 100 (prior art) | 70% | 67% | 133% |
| CAT 200 (prior art) | 33% | 100% | 40% |
| CAT 300 (prior art) | 16% | 20% | 33% |
| CAT 500 (present invention) | 111% | 100% | 125% |

As can be seen in Table 1 and accompanying FIG. 1, the iMeHs of the present invention (CAT 500) maintains its hydroprocessing activity in the oxidized state to a significantly greater extent as compared to the iMeHs of the prior art (CAT 100, CAT 200, and CAT 300) for all three of the model compounds. In fact, only the CAT 500 of the present invention actually maintains or in some cases improves its hydroprocessing activity after oxidation for all three (3) of the model compounds tested.

The matrix of the iMeHs of the present invention can have a crystalline or amorphous structure. These iMeHs is especially suited to accommodating monatomic hydrogen extracted from molecular hydrogen. The quantity of atomic hydrogen in the interstitial metallic hydrides has a measurable value, which is a function of alloy composition, and operating temperature and hydrogen partial pressure. In an iMeH, the ratio of hydrogen to metal atoms may vary over a range and may not be expressible as a ratio of small whole numbers. The iMeH compounds of the present invention are able to dissociate diatomic hydrogen molecules at the surface into monatomic hydrogen, absorb copious amounts of monatomic hydrogen thus produced into the metal alloy, and desorb the monatomic hydrogen under the appropriate conditions. A heat of absorption is produced when the molecular hydrogen dissociates into atomic hydrogen and the hydrogen atoms position themselves interstitially in the structure of the material. Additional energy at a suitable steady state process temperature and pressure is required for the release of monatomic hydrogen from within the catalyst. This energy can be derived from the process heat of reaction or from external application of energy or both.

Interstitial metal hydrides are produced by preparing samples of the constituent metals in the desired proportions, and combining them and heating them so that they melt together homogeneously to produce a metal alloy. The resulting metal alloy is then exposed to hydrogen at a temperature and pressure characteristic of the alloy so that the metal alloy takes up the hydrogen in monatomic form.

The iMeH materials of the present invention are typically prepared by a volumetric (gas to solid alloy) method at a known temperature and pressure using a stainless steel reactor. The metallic hydride will absorb hydrogen with an exothermic reaction. This hydrogenation process is reversible according to the following chemical reaction schematic:

Metal Alloy+H₂⇄iMeH+Energy

As noted, the hydrogen absorption is accompanied by an exothermic/endothermic exchange of energy. Hydrogen uptake/release is also accompanied by volume expansion/contraction of the iMeH which under certain conditions can be high as about 20 to 25 vol %. During this process, hydrogen atoms will occupy interstitial sites in the alloy lattice. This hydrogen absorption/desorption by an iMeH can be measured and characterized in a Pressure-Composition-Temperature (“PCT”) plot or graph.

The metal alloy from which an iMeH is produced can be prepared by mechanical or induction heated alloying processes. The metal alloy can be stoichiometric or non-stoichiometric. Non-stoichiometric compounds are compounds that exhibit wide compositional variations from ideal stoichiometry. Non-stoichiometric systems contain excess elements, which can significantly influence the phase stability of the metallic hydrides. The iMeH is produced from a metal alloy by subjecting the alloy to hydrogen at a pressure and temperature that is a characteristic of the particular alloy.

The iMeH catalysts of the present invention can be selected to have a desired lattice structure and thermodynamic properties, such as the applied pressure and temperature at which they can be charged and the operating pressure and temperature at which they can be discharged. These working thermodynamic parameters can be modified and fine tuned by an appropriate alloying method and therefore, the composition of the catalysts can be designed for use in a particular catalytic process.

The terms “interstitial metal hydride” or “iMeH”, when used, are meant to refer solely to the iMeH component or components. The terms “iMeH catalysts” or “iMeH containing catalysts” as used herein are equivalents and are used as a generic term to cover any catalysts (including catalysts consisting of iMeH(s)), co-catalysts, or catalyst systems which are comprised of an iMeH component.

The CAT 500 iMeHs of the present invention can be utilized by themselves as an active catalyst or as a co-catalyst with additional catalytic materials. By the term “co-catalyst” as used herein, it is meant that the iMeH component is either made into a catalyst particle along with other catalytic elements(s), or alternatively, one catalyst particle can be comprised of the iMeH component and mixed with a separate catalyst particle comprised of the catalytic elements(s). Preferred catalytic elements include, but are not limited to Group 6, 8, 9 and 10 elements. More preferred catalytic elements for use with the iMeHs of the present invention are Mo, W, Fe, Co, Ni, Pd, Pt, and combinations thereof. The even more preferred catalytic elements for use with the high severity hydroprocessing iMeHs of the present invention are Mo, W, Co, Ni, and combinations thereof. In a most preferred embodiment, the co-catalyst is comprised of a high severity hydroprocessing iMeH of the present invention and Mo. In another most preferred embodiment, the co-catalyst is comprised of a high severity hydroprocessing iMeH of the present invention, Mo, and either Co, Ni or a combination thereof. In the present invention, the “co-catalyst” systems are a preferred embodiment.

The CAT 500 iMeHs of the present invention exhibit significantly improved activity after oxidation when utilized at the high temperatures and pressures at which most commercial hydroprocessing processes operate. In particular these high severity processes include, but are not limited to, hydrogenation, hydrocracking, hydrodesulfurization, hydrodenitrogenation, and hydrodemetalization processes. These iMeH metals can absorb and release hydrogen in its monatomic state which is more reactive with the hydrocarbons in the process than the diatomic hydrogen typically present in the processes. However, when the monatomic hydrogen is released from the iMeH surface, it is also highly reactive with other monatomic hydrogen in the system. Therefore, it is desired that the additional catalytic elements in the co-catalyst be located in very close proximity to the CAT 500 iMeH to allow the monatomic hydrogen released to react at the active catalytic sites with the hydrocarbon molecules or heteroatoms (such as sulfur, nitrogen, and metals) in the hydrocarbons to form molecular heteroatom compounds (e.g., hydrogen sulfide) that can be easily removed from the hydroprocessed product stream.

The CAT 500 iMeHs of the present invention can be combined with known hydroprocessing catalysts such as noble metals, metal oxides, metal sulfides, zeolitic acid or base sites to further promote hydroprocessing of feedstocks such as organic compounds. These iMeH materials can be combined with other hydroprocessing materials in a variety of ways to build an optimized catalyst for a particular reaction or function. In general, the finer the powders being mixed (e.g. support, iMeH), the higher the surface area and the more intimate the mixing.

The iMeH catalysts can be used in a powder, extrudate, or preformed matrix form based upon the type of reactor design selected (e.g., fluidized bed, fixed bed, catalytic monolith, etc.). The simplest CAT 500 iMeH catalyst is the iMeH powder itself. In this case the iMeH provides monatomic hydrogen and is the catalyst for hydroprocessing. The iMeH catalysts of the present invention, when used in powder form, may be mixed and dispersed within the feedstock and transported through a reactor (e.g. slurry reactor). After the desired reaction has been catalyzed in the reactor, the iMeH powder can then separated from the reaction products for reuse.

The CAT 500 iMeH can be combined with a support and optionally other catalytic elements to produce a composite catalyst. The support provides for the physical dispersion of iMeH, providing greater surface area and ease of handling. The support also serves to increase the surface area of the active catalytic elements and thereby increase the process reaction rates. The support can also add acidic or basic sites that can enhance the catalytic activity of other catalyst components or acts as catalysts themselves. The support also serves to disperse the metallic or metal oxide catalytic sites so as to prevent arcing in the presence of a strong electric or magnetic fields that may be used to expedite catalytic action. The catalyst may further comprises a radio frequency or microwave absorber in thermal contact with the interstitial metal hydride. These absorbers are preferably added metal elements or metal compounds with a high dielectric constant.

The CAT 500 iMeH compositions of the present invention can be utilized in a crystalline or amorphous form. The support may be composed of an inorganic oxide, a metal, a carbon, or combinations of these materials. In preferred embodiments of the present invention, the support is comprised of alumina, silica, titania, zirconia, MCM-41 or combinations thereof. The iMeH phases and catalytic elements can be dispersed as mechanically mixed powders, or can be chemically dispersed, impregnated or deposited. When mixed powders are used in the present invention, the powder particle size is controlled to provide a powder that has particles that are small enough to provide suitable surface area and reactivity, but not so fine as to produce significant surface oxidation. Other catalytic elements included in the co-catalyst or catalyst systems of the present invention may be noble metals such as platinum or palladium, Group 6, 8, 9 and 10 metal oxides and/or metal sulfides, and zeolite acid or base sites. A hydroprocessing component and a hydrocracking component used in combination with the CAT 500 iMeH may be one or more of these catalytic elements. Both the combination of an iMeH powder with a support, which can provide an additional catalyst function (i.e. at catalytically active or inert support), or an iMeH dispersed onto a hydroprocessing catalytic powder, can be especially effective for hydrocracking in a fluidized bed or ebullating bed reactor.

The hydrogen atoms occupy interstitial sites in the alloy lattice of the iMeH and the ratio of hydrogen to metal atoms may vary over a range and may not be expressible as a ratio of small whole numbers. The iMeH compositions of the present invention are also able to dissociate diatomic hydrogen molecules at the surface into monatomic hydrogen (i.e., hydrogen atoms), absorb significant amounts of monatomic hydrogen thus produced, and subsequently desorb a portion of the stored monatomic hydrogen under the appropriate conditions.

In other preferred embodiments of the catalyst of the present invention, the CAT 500 iMeH catalyst is used in a co-catalyst with at least one catalytic element selected from Mo, W, Fe, Co, Ni, Pd, Pt, as well as combinations thereof. In a more preferred embodiment the CAT 500 iMeH catalyst is used in a co-catalyst with at least one catalytic element selected from Mo, W, Co, Ni, as well as combinations thereof. The even more preferred catalytic elements for use with CAT 500 in co-catalysts are Mo, W, Co, Ni, and combinations thereof. In a most preferred embodiment, the co-catalyst is comprised of a CAT 500 and Mo. In another most preferred embodiment, the co-catalyst is comprised of a CAT 500, Mo, and either Co, Ni or a combination thereof.

In preferred process embodiments of the present invention, these CAT 500 iMeH catalysts are utilized in a hydroprocessing process wherein the operating (or “reaction”) conditions are at least 400 psig and at least 200° C. More preferred reaction conditions are at least 600 psig and at least 250° C. Preferred hydrogen partial pressures are at least about 350 psia, and even more preferably at least about 500 psia. Most preferably the reaction conditions are within the operating envelope of about 200° C. to about 450° C. with an operating pressure of from about 400 psig to about 2500 psig.

In a preferred embodiment of the present invention, a hydrocarbon stream and/or the heavy hydrocarbon stream containing at least 1 wt % sulfur and more preferably at least 3 wt % sulfur is contacted with a catalyst, co-catalyst, or catalyst system containing a CAT 500 iMeH in the presence of hydrogen at a temperature of at least 200° C. and at least 400 psig. In other preferred embodiments of the present invention, the hydrocarbon stream and/or the heavy hydrocarbon stream that is desulfurized in the present process contains polycyclic sulfur heteroatom complexes which are difficult to desulfurize by conventional methods.

Although not required for the use of the present invention, the catalytic activity of the oxidation resistant CAT 500 iMeH-containing catalysts of the present invention can be enhanced and controlled by exposing the catalyst to radio frequency (“RF”) energy (about 3×10⁵ Hz to about 3×10⁸ Hz) or microwave energy (about 3×10⁸ Hz to about 3×10¹² Hz), either in the absence of, the presence of, or in sequence with conventional fuel fired heating or resistive heating. The RF or microwave energy can provide for a significant increase in hydroprocessing efficiency in comparison to conventional heating. Furthermore the microwave energy can be modulated and controlled in such a manner as to optimize the reaction exchange of the monatomic hydrogen from the iMeH. In one embodiment of the invention, the iMeH catalyst component is placed in contact with a separate absorber of RF or microwave energy. The separate absorber of RF or microwave energy absorbs the energy and transfers it to the iMeH through thermal conduction or convection, and may be one or more compounds such as silicon carbide, iron silicide, nickel oxide, and tungsten carbide. In another embodiment of the invention, the iMeH component functions as the primary absorber of RF or microwave energy. When used with microwave enhancement, the iMeH component is sufficiently dispersed within the catalyst and feedstock combination to solve the problem of hot spots and arcing generally associated with the introduction of metals into a microwave or RF field.

The selective use of RF or microwave energy to drive the catalytic component of the catalyst aids in the release of the iMeH monatomic hydrogen into the feedstock. It is cost effective to maximize the use of fossil fuels to pre-heat the feedstocks to near reaction temperatures, and use minimum RF or microwave energy to drive and control the hydroprocessing reactions. Ideally there will be a minimized or zero net temperature increase from the RF or microwave energy into the catalyst support or into the feedstock because this energy is primarily targeted into the iMeH to enhance the reaction exchange of monatomic hydrogen. Selective coupling of the RF or microwave energy is accomplished through selection and control of the relative dielectric parameters of the catalyst's components and the feedstock. This results in efficient, economically viable catalytic processes, which are enhanced using microwaves.

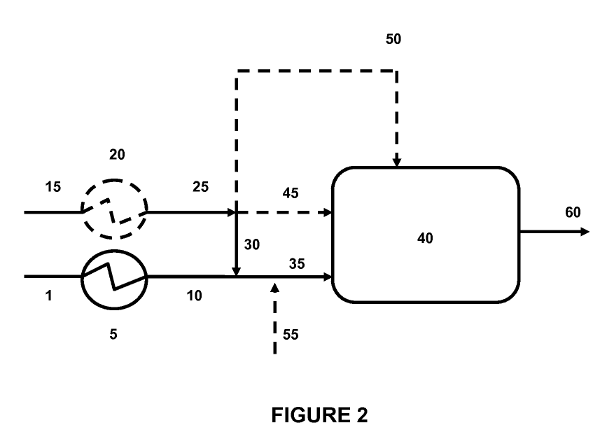

A schematic of a preferred process configuration using the CAT 500 iMeHs of the present invention is shown in FIG. 3 wherein the incoming hydrocarbon feedstream is heated to a target temperature prior to entering the reactor and the RF or microwave energy is introduced into the reactor itself. FIG. 2 shows a preferred embodiment of the present invention wherein a single stage reactor unit is utilized. Here, a hydrocarbon stream (1) is heated to a predetermined elevated temperature utilizing a fired heater or heat exchange unit (5) to produce a heated hydrocarbon feedstream (10). Similarly a hydrogen-rich stream (15) can be heated, if necessary, a fired heater or heat exchange unit (20) to produce a heated hydrogen-rich stream (25). The term “hydrogen-rich stream” as used herein is a stream containing at least 50 mole percent (mol %) of diatomic hydrogen. In a preferred embodiment, at least a portion of the heated hydrogen-rich stream (25) is combined via (30) with the heated hydrocarbon feedstream (10) to form a heated combined hydrocarbon feedstream (35) which is fed to the hydroprocessing reactor unit (40). In an optional embodiment, some, or all, of the heated hydrogen-rich stream enters directly into the hydroprocessing reactor unit (40) via line (45). Even more preferably, at least some of the heated hydrogen-rich stream (25) is fed to various points (50) within the hydroprocessing reactor unit (40) itself. This added hydrogen in the reaction process assists in maintaining a sufficient hydrogen concentration within the reactor itself as well as providing fresh hydrogen for absorption/desorption by the CAT 500 iMeH catalyst present.

Continuing with FIG. 2, in a preferred embodiment, the oxidation resistant CAT 500 iMeH catalyst, co-catalyst, or catalyst system is substantially maintained in the hydroprocessing reactor unit (40) itself. However, in other embodiments, a portion or all of the oxidation resistant CAT 500 iMeH catalyst, co-catalyst, or catalyst system is introduced into the feedstream entering the reactor (55) as a slurry or particulate catalyst. Although the oxidation resistant iMeH catalyst, co-catalyst, or catalyst system is shown entering the feedstream system at point (55), the oxidation resistant iMeH catalyst, co-catalyst, or catalyst system can be entered in to either the hydrocarbon feedstream, the heated hydrocarbon feedstream, and/or the hydrogen-rich stream at any point prior to entering the hydroprocessing reactor unit (40). In a preferred embodiment, RF or microwave energy is supplied to the catalyst/hydrocarbon/hydrogen mixture in the hydroprocessing reactor (40) to assist in promoting the absorption and desorption of the monatomic hydrogen in the iMeHs present. Continuous, pulsed, frequency modulated and/or two or more frequencies of RF or microwave energy may be utilized.

It is preferred that the reaction conditions in the hydroprocessing reactor (40) be at least 200° C. and at least 400 psig. Preferred reaction conditions are at least 250° C. and at least 600 psig. Preferred hydrogen partial pressures are at least about 350 psia, and even more preferably at least about 500 psia. Most preferably the reaction conditions are about 200° C. to about 450° C. with an operating pressure of from about 400 psig to about 2500 psig. A reaction product stream (60) is withdrawn from the hydroprocessing reactor (40). This stream will typically contain some gaseous hydrocarbon products and hydrogen. These gaseous products can be separated by processes known in the art and a hydrocarbon product stream with improved product qualities is retrieved.

Hydroprocessing configurations utilizing the oxidation resistant CAT 500 iMeH catalysts of the present invention, which incorporate additional process stages and hydroprocessing reactors to those described above may be also be used in the processes of the present invention and may also be coupled with interstage and/or inter-reactor separations steps to separate liquid hydrocarbon-containing reaction streams from gaseous hydrocarbon-containing reaction streams and/or to incorporate separation steps for separating the catalysts from the hydrocarbons in order to improve overall selectivity and conversion of the final hydrocarbon products as would be obvious to one of skill in the art in light of the present invention disclosure.

The oxidation resistant CAT 500 iMeH catalysts, co-catalysts and catalyst systems of the present invention can be used in any hydroprocessing process. The term “hydroprocessing” (or equivalent term “hydrotreating”) as used herein is a general term and is defined as all catalytic processes involving hydrogen. This includes the reaction of any petroleum fraction with hydrogen in the presence of a catalyst. This includes processes which remove undesirable impurities such as sulfur, nitrogen, metals, and unsaturated compounds in the presence of hydrogen and a catalyst. Examples include, but are not limited to, hydrogenation, hydrocracking, hydrodesulfurization, hydrodenitrogenation hydrodemetalization, and catalytic hydrodewaxing.

Specific hydroprocessing processes wherein the oxidation resistant CAT 500 iMeH catalysts, co-catalysts and catalyst systems of the present invention can be used include, but are not limited to the following processes as defined:

The term “hydrogenation” as used herein is defined as any process wherein a hydrocarbon feedstream is contacted with a catalyst and hydrogen at an elevated pressure and temperature wherein hydrogen is chemically added to at least a portion of the hydrocarbon compounds in the hydrocarbon feedstream, thereby increasing the hydrogen content of the hydrocarbon compounds. Preferred hydrogenation applications include the hydrogen addition to “unsaturated” olefinic or aromatic hydrocarbon compounds (e.g., olefin hydrogenation or aromatic hydrogenation). Hydrogenation is a subset of hydroprocessing processes.

The term “hydrocracking” as used herein is defined as any process wherein a hydrocarbon feedstream is contacted with a catalyst and hydrogen at an elevated pressure and temperature wherein at least a portion of the hydrocarbon feedstream is converted into lower-boiling point products thereby resulting in an overall lower average boiling point product stream based on wt %. Hydrocracking is a subset of hydroprocessing processes.

The term “hydrodesulfurization” or “HDS” as used herein is defined as a process in which a hydrocarbon feedstream is contacted with a catalyst and hydrogen at an elevated pressure and temperature wherein at least a portion the sulfur elements or compounds present in hydrocarbon feedstream are removed thereby resulting in at least one hydrocarbon product with a lower sulfur content than the hydrocarbon feedstream. Hydrodesulfurization is a subset of hydroprocessing processes.

The term “hydrodenitrogenation” or “HDN” as used herein is defined as a process in which a hydrocarbon feedstream is contacted with a catalyst and hydrogen at an elevated pressure and temperature wherein at least a portion the nitrogen elements or compounds present in hydrocarbon feedstream are removed thereby resulting in at least one hydrocarbon product with a lower nitrogen content than the hydrocarbon feedstream. Hydrodenitrogenation is a subset of hydroprocessing processes.

The term “hydrodemetalization” or “HDM” as used herein is defined as a process in which a hydrocarbon feedstream is contacted with a catalyst and hydrogen at an elevated pressure and temperature wherein at least a portion the metal elements or compounds present in hydrocarbon feedstream are removed thereby resulting in at least one hydrocarbon product with a lower metal content than the hydrocarbon feedstream. Hydrodemetalization is a subset of hydroprocessing processes.

The term “catalytic hydrodewaxing” as used herein is defined as a catalytic hydrocracking process which uses molecular sieves, preferably zeolites, to selectively hydrocrack and/or isomerize waxes (i.e., long chain paraffinic molecules with greater than about 22 carbon molecules) present in the hydrocarbon streams to smaller carbon content molecules thereby resulting in an overall lower average boiling point product stream based on wt %. Catalytic hydrodewaxing is a subset of hydroprocessing processes.

Although the present invention has been described in terms of specific embodiments, it is not so limited. Suitable alterations and modifications for operation under specific conditions will be apparent to those skilled in the art. It is therefore intended that the following claims be interpreted as covering all such alterations and modifications as fall within the true spirit and scope of the invention.

### EXAMPLES

### Example 1

This example describes how the CAT 500 iMeH catalysts of the current invention, as well as the CAT 100, CAT 200, and CAT 300 iMeH catalysts of the prior art were fabricated. These catalysts were utilized for the performance testing described in Example 2 herein.

### Chemical Composition of Tested Materials

The chemical compositions of the iMeHs tested in the Examples were as follows:

CAT 100=Mm_{1.1}Ni_{4.22}Co_{0.42}Al_{0.15}Mn_{0.15}

CAT 200=Nd_{2.05}Dy_{0.25}Fe₁₃B_{1.05}

CAT 300=Mg_{1.05}Ni_{0.95}Cu_{0.07}

CAT 500=ZrNi

Sample Preparation for the CAT 500 iMeHs of the Present Invention

The metal alloys based on zirconium-nickel were prepared by melting together the appropriate stoichiometric amounts of metals with purity of 99.9% (from Alfa Aesar/Johnson Matthey Company™) in an argon atmosphere using water cooled copper hearth argon arc furnace Model CENTORR® from Centorr Vacuum Industries™, Nashua, N.H. Each arc-melted ingot was flipped over and re-melted three times and was normally held in the liquid state for approximately 30 seconds to insure complete mixing of the starting materials. The reduction in the sample weight was negligible.

To obtain single phase materials the cast samples were sealed in quartz tubes, filled with ⅓ atmosphere of argon gas and annealed at 950° C. for a period of 3 to 5 days using a Thermo scientific Lindberg/Blue™ tube furnace. The samples in the tubes were water quenched to avoid a possible phase transition during the cooling process.

The crystal structure and homogeneity of the samples were determined by powder X-ray diffraction. The CAT 500 samples were found to have a crystal structure of orthorhombic CrB type.

Sample Preparation for the CAT 100, CAT 200, and CAT 300 iMeHs of the Prior Art

The preparation of these metal alloys (CAT 100, CAT 200, CAT 300), annealing process and XRD measurement followed the same methods as described above for the CAT 500 preparation described above.

CAT 100 is based on Mm (Ni, Co, Al, Mn)₅ with a purity of approximately 99.5% for Mm (mischmetal or mixed rare earth), and about 99.9% for Ni, Co, Al and Mn. The weight losses due to evaporation of the Mm elements during the melting were compensated by starting with an excess of approximately 3 wt % of Mm. The crystal structure was determined to be hexagonal with CaCu₅ type.

CAT 200 is based on NdFeBDy with a purity of approximately 99.9%. The weight loss for Nd, Dy during melting was approximately 3%. The crystal structure is tetragonal with Nd₂Fe₁₄B type.

CAT 300 is based on Mg₂NiCu with a purity of about 99.9%. Due to high volatility of Mg the weight loss was about 10%. Excess Mg is added to allow for this loss. The crystal structure is cubic with MoSi₂ type.

### Sample Preparation and Activation

The metal alloy bulk was crushed manually to an average particle size of approximately 200 μm (microns). The hard alloy samples were milled mechanically at cryogenic temperatures (approximately 80° K) and then were attrited. All samples were sieved to under approximately 200 μm (microns).

All particle size preparations of the samples were performed under inert nitrogen atmosphere conditions. The average particle size distribution was obtained using Horiba Laser-La-920® Particle Analyzer, from HORIBA Instruments™, Inc., Irvine, Calif.

Approximately 4 to 5 grams of metal alloy powder with known molecular weight was then placed into the stainless steel reactor connected to the Hy-Energy™ system. The reactor was then purged with hydrogen three times. H₂ pressure is introduced to the sample chamber from about 500 psig to about 800 psig at ambient temperature (i.e., 25° C.) and a waiting period is given to observe if any absorption takes place. A pressure drop in the reactor, generally in the range of about 20 psig depending on the amount of hydrogen absorbed, will indicate the hydrogen activation process. Typical waiting period times are from 10 to 30 minutes. If no absorption occurs, then the temperature is raised to about 250° C. The temperature needed to activate the sample depends on the active surface of the alloy. The sample starts absorbing hydrogen which is an exothermic process. The hydrogen activated sample is then cooled down to ambient temperature and pressure to achieve maximum hydrogen absorption.

### Example 2

This example calculates and compares the % maintenance of hydroprocessing activity after oxidation of the interstitial metal hydrides (“iMeHs”) of the prior art (CAT 100, CAT 200, and CAT 300) to those of the oxidation resistant iMeHs (CAT 500 compositions) of the present invention at conditions of 200° C. and 400 psig. The % maintenance of hydroprocessing activity after oxidation is based on a ratio of each iMeH's first order rate constant after oxidation divided by the iMeH's first order rate constant prior to oxidation (expressed in percentage, %) for each of the three model compounds tested.

In this example, a sample of each iMeH was tested in each of the “non-oxidized” condition and in the “oxidized” condition. The “non-oxidized” iMeH samples and the “oxidized” iMeH samples utilized in the testing of this example were prepared as follows.

Handling & Preparation of “Non-Oxidized” iMeH Samples

After charging with hydrogen, the hydride is attrited to an average particle size of 5 μm (microns) under nitrogen. After attrition the powder is loaded into a press and formed into a pellet at 30 tons for 10 minutes. The entire apparatus is enclosed in a nitrogen atmosphere for the duration of the procedure. After pressing the sample is transferred to a glove box where it is crushed, then sized to 90-300 μm (microns) for hydrotreating activity testing. When transfer of the sample was required (e.g. between hydriding and attritting or between pressing and sizing) the container is purged with nitrogen then sealed.

Handling & Preparation of “Oxidized” iMeH Samples

After charging with hydrogen, the hydride is attrited to an average particle size of 5 μm (microns) under nitrogen. After attrition the powder is loaded into a press and formed into a pellet at 30 tons for 10 minutes. This procedure was conducted open to the laboratory atmosphere without any special precautions taken. After pressing the sample is crushed, and then sized to 90-300 μm (microns) for testing in the laboratory atmosphere.

### Hydrotreating Activity of the Interstitial Metal Hydrides

Each iMeH sample was tested for hydroprocessing (i.e., hydrotreating) activity under similar severe hydroprocessing conditions of 200° C. and 400 psig in both their non-oxidized and oxidized conditions. A mixture of three (3) model compounds was utilized in this testing to observe the conversion rates of typical compounds found in heavy hydrocarbons whose conversion is targeted for product upgrading under hydroprocessing conditions. The testing and results for each iMeH sample in this example were performed according to the following procedures.

The reactor testing unit consisted of a multi-well, high-pressure batch reactor that holds 48×3 mL alumina vials. The vials are covered with a plate containing 48 pinholes to allow gas flow into and out of the vials, but limit liquid losses. The “non-oxidized” iMeH and feed loading and unloading were done in a glove box under nitrogen. The “oxidized” iMeH samples were loaded in an open laboratory atmosphere and left in that oxygen containing environment for at least 8 hours before testing. Unloading was conducted in a glove box under nitrogen. The iMeH was added in 32.5 microliter increments to 1.5 mL of feed to simulate space velocity. Mixing was accomplished with an orbital shaker at 300 rpm. A feed mixture containing three model compounds was used for catalyst activity evaluation. The feed mixture was poly alpha olefin based (PAO, 6 centistokes) and spiked with 0.3 wt % dibenzothiophene (DBT), 0.3 wt % 4,6-diethyl-dibenzothiophene (DEDBT), and 1 wt % 1-n-dodecylnaphthalene (C12N). Each reactor was purged with nitrogen and then hydrogen prior to activity testing. The reaction gas was 100% hydrogen. Activity testing was conducted at 200° C. and 400 psig, and held at those conditions for approximately 23 hrs. After which the reactor was cooled to room temperature and purged with nitrogen. Products were removed from the vials and subject to GC analysis.

The first order rate constants were then calculated from the results for each of the iMeH samples tested (both non-oxidized and oxidized conditions) for each of the model compounds and the ratio of the first order rate constant (oxidized) to the first order rate constant (non-oxidized) was calculated for each iMeH sample for each of the three (3) model compounds to show the percentage of the original hydroprocessing activity (based on the non-oxidized sample) is maintained after the sample has been oxidized. The results from the testing of this example are presented in Table 1 and are shown graphically in FIG. 1, herein.

1. A catalyst comprised of an interstitial metal hydride having a compositional formula of A₁₋ₓBₓT_{(1-y)±d1}C_{y±d2}, wherein:
A=Zr; B=at least one of Ti and Hf; T=Ni; C=at least one of Cr, Mn, Fe, Co, and Cu; and
x=0.0 to 1.0; and y=0.0 to 1.0; and
d₁=0.00 to 0.2; and d₂=0.00 to 0.2.

2. The catalyst of claim 1, wherein the interstitial metal hydride has been exposed to an oxidizing atmosphere.

3. The catalyst of claim 2, wherein the interstitial metal hydride the oxidizing atmosphere is air.

4. The catalyst of claim 1, wherein the interstitial metal hydride is oxidized.

5. The catalyst of claim 1, wherein the catalyst is further comprised of at least one transition metal element selected from Mo, W, Fe, Co, Ni, Pd, and Pt.

6. (canceled)

7. The catalyst of claim 1, wherein the catalyst is further comprised of Mo and at least one transition metal element selected from Co, Ni, and combinations thereof.

8. The catalyst of claim 1, wherein the interstitial metal hydride and the transition metal element are bound in a matrix comprised of alumina, silica, titania, zirconia, MCM-41 or combinations thereof.

9. The catalyst of claim 1, wherein d₁=0 and d₂=0.

10. (canceled)

11. The catalyst of claim 1, wherein the catalyst further comprises a radio frequency or microwave absorber in thermal contact with the interstitial metal hydride.

12. The catalyst of claim 1, wherein B═Ti.

13. (canceled)

14. The catalyst of claim 1, wherein B═Ti and C=at least one of Mn and Fe.

15. (canceled)

16. (canceled)

17. (canceled)

18. (canceled)

19. A process for upgrading a hydrocarbon feedstream comprised of:
a) contacting a hydrocarbon feedstream with a catalyst comprised of an interstitial metal hydride in the presence of hydrogen at process reaction conditions of at least 200° C. and at least 400 psig; and
b) obtaining an upgraded reaction product stream;
wherein the interstitial metal hydride has a compositional formula of A₁₋ₓBₓT_{(1-y)±d1}C_{y±d2}, wherein:
A=Zr; B=at least one of Ti and Hf; T=Ni; C=at least one of Cr, Mn, Fe, Co, and Cu; and
x=0.0 to 1.0; and y=0.0 to 1.0; and
d₁=0.00 to 0.2; and d₂=0.00 to 0.2.

20. The process of claim 19, wherein the interstitial metal hydride has been exposed to an oxidizing atmosphere prior to contacting the hydrocarbon feedstream.

21. The process of claim 20, wherein the interstitial metal hydride the oxidizing atmosphere is air.

22. (canceled)

23. The process of claim 19, wherein the catalyst is further comprised of at least one transition metal element selected from Mo, W, Fe, Co, Ni, Pd, and Pt.

24. (canceled)

25. The process of claim 19, wherein the catalyst is further comprised of Mo and at least one transition metal element selected from Co, Ni, and combinations thereof.

26. The process of claim 23, where the transition metal element is in the sulfided metal condition.

27. The process of claim 19, wherein process reaction conditions are from are from about 200° C. to about 450° C. and from about 400 psig to about 2500 psig.

28. The process of claim 19, wherein step a) is performed in the presence of a hydrogen-rich gas containing at least 50 mol % hydrogen.

29. (canceled)

30. The process of claim 19, wherein the hydrocarbon feedstream and interstitial metal hydride are further subjected to radio frequency energy or microwave frequency energy while under the reaction conditions.

31. (canceled)

32. The process of claim 23, wherein the hydrocarbon feedstream is a heavy hydrocarbon feedstream with an API gravity of less than 20 and a sulfur content of at least 1 wt % sulfur.

33. The process of claim 19, wherein the hydrocarbon feedstream is comprised of a biofuel.

34. (canceled)

35. The process of claim 19, wherein the hydrocarbon feedstream substantially consists of a biofuel.

36. (canceled)

37. (canceled)

38. (canceled)

39. (canceled)

40. (canceled)

41. (canceled)

42. (canceled)

43. The process of claim 19, wherein the catalyst further comprises a radio frequency or microwave absorber in thermal contact with the interstitial metal hydride.

44. The process of claim 19, wherein B═Ti and C=at least one of Mn and Fe.

45. (canceled)

46. (canceled)

47. (canceled)

48. (canceled)
